(19) United States
(12) Patent Application Publication
(10) Pub. No.: US 2008/0198923 A1
(43) Pub. Date: Aug. 21, 2008

(54) CONTENT SIGNAL MODULATION AND DECODING

(76) Inventors: Michael S. Gramelspacher, Greenfield, IL (US); Rory T. Sledge, O'Fallon, IL (US)

Correspondence Address: SCHWEGMAN, LUNDBERG & WOESSNER, P.A., P.O. BOX 2938, MINNEAPOLIS, MN, 55402, US

(21) Appl. No.: 11/967,702

(22) Filed: Dec. 31, 2007

Related U.S. Application Data
(60) Provisional application No. 60/883,700, filed on Jan. 5, 2007.
(60) Provisional application No. 60/887,501, filed on Jan. 31, 2007.

(51) Int. Cl. H04N 7/24

(52) U.S. Cl. 375/240.01; 375/E07.003

(57) ABSTRACT

Methods and systems for content signal encoding and decoding are described. A message to be encoded into a content signal may be accessed. The content signal may include a plurality of frames. One or more symbols to be encoded for the message may be derived in accordance with a message translator. A particular symbol of the one or more symbols may be embedded into at least one frame of the plurality of frames by altering a total pixel variable value of the at least one frame.

### CROSS-REFERENCE TO RELATED APPLICATIONS

This application claims the benefit of U.S. Provisional Patent Applications entitled “Content Signal Modulation and Detection”, Ser. No.: 60/883,700, filed 5 Jan. 2007 and “Content Signal Modulation and Detection”, Ser. No.: 60/887,501, filed 31 Jan. 2007, the entire contents of which are herein incorporated by reference.

### FIELD

This application relates to a method and system for signal processing, and more specifically to methods and systems for content signal encoding and decoding.

### BRIEF DESCRIPTION OF DRAWINGS

Embodiments are illustrated by way of example and not limitation in the figures of the accompanying drawings, in which like references indicate similar elements and in which:

FIG. 1 is a block diagram of an example encoding system according to an example embodiment;

FIG. 2 is a block diagram of an example decoding system according to an example embodiment;

FIG. 3 is a block diagram of an example encoder subsystem that may be deployed in the encoding system of FIG. 1 according to an example embodiment;

FIG. 4 is a block diagram of an example decoder subsystem that may be deployed in the decoding system of FIG. 2 according to an example embodiment;

FIG. 5 is a block diagram of an example decoder subsystem that may be deployed in the decoding system of FIG. 2 according to an example embodiment;

FIG. 6 is a flowchart illustrating a method for content signal encoding in accordance with an example embodiment;

FIGS. 7 and 8 are flowcharts illustrating a method for signal decoding in accordance with an example embodiment;

FIG. 9 is a flowchart illustrating a method for message decoding in accordance with an example embodiment;

FIG. 10 is a flowchart illustrating a method for total pixel variable value utilization in accordance with an example embodiment;

FIG. 11 is a block diagram of an example display according to an example embodiment;

FIG. 12 is a flowchart illustrating a method for signal circumvention in accordance with an example embodiment;

FIG. 13 is a block diagram of an example encoder that may be deployed in the encoding system of FIG. 1 according to an example embodiment;

FIG. 14 is a block diagram of an example optical decoder that may be deployed in the decoding system of FIG. 2 according to an example embodiment;

FIG. 15 is a block diagram of an example optical sensor device according to an example embodiment;

FIG. 16 is a block diagram of an example inline decoder that may be deployed in the decoding system of FIG. 2 according to an example embodiment; and

FIG. 17 illustrates a diagrammatic representation of a machine in the example form of a computer system within which a set of instructions for causing the machine to perform any one or more of the methodologies discussed herein may be executed.

### DETAILED DESCRIPTION

Example methods and systems for content signal encoding and decoding are described. In the following description, for purposes of explanation, numerous specific details are set forth in order to provide a thorough understanding of example embodiments. It will be evident, however, to one skilled in the art that the present invention may be practiced without these specific details.

In an example embodiment, a message to be encoded into a content signal may be accessed. The content signal may include a plurality of frames. One or more symbols to be encoded for the message may be derived in accordance with a message translator. A particular symbol of the one or more symbols may be embedded into at least one frame of the plurality of frames by altering a total pixel variable value of the at least one frame.

In an example embodiment, total pixel variable value of a frame of a content signal may be calculated. An average total pixel variable value of a plurality of preceding frames may be calculated. The total pixel variable value of the frame may be compared to the average total pixel variable value of the plurality of proceeding frames to determine whether the frame has been encoded.

In an example embodiment, charge received may be accumulated for a number of intervals during one or more symbol periods. The accumulated charge may be received through use of a photodetector from an encoded content signal presented on a display device. At least one sample of the accumulated charge may be taken during a particular symbol period of the one or more symbol periods. A message encoded within the encoded content signal may be decoded in accordance with the at least one sample.

In an example embodiment, charge received for a number of intervals may be accumulated during one or more symbol periods. The accumulated charge may be received through use of a photodetector from an encoded content signal presented on a display device. At least one sample of the accumulated charge may be taken during a particular symbol period of the one or more symbol periods. At least one encoded frame within the encoded content signal may be identified in accordance with the at least one sample. The at least one encoded frame may be associated with a message. The encoded content signal may be altered in accordance with the identifying of the at least one encoded frame to scramble the message within the encoded content signal.

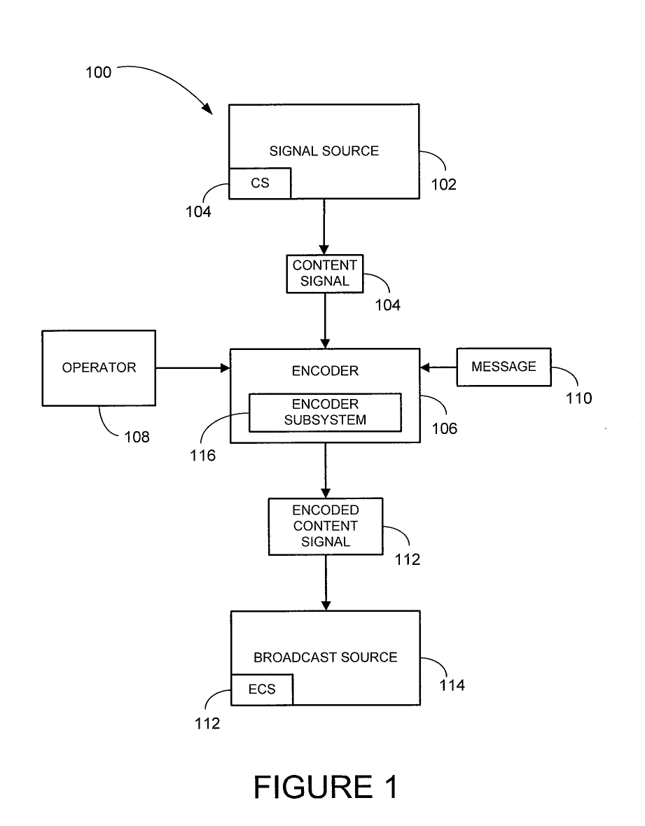

FIG. 1 illustrates an example encoding system 100 according to an example embodiment. The encoding system 100 is an example platform in which one or more embodiments of an encoding method may be used. However, other platforms may also be used.

A content signal 104 may be provided from a signal source 102 to an encoder 106 in the encoding system 100. The content signal 104 is one or more images and optionally associated audio. Examples of the content signal 104 include standard definition (SD) and/or high definition (HD) content signals in NTSC (National Television Standards Committee), PAL (Phase Alternation Line), SECAM (Systeme Electronique Couleur Avec Memoire), a MPEG (Moving Picture Experts Group) signal, one or more JPEGs (Joint Photographic Experts Group) sequence of bitmaps, or other signal formats that transport of a sequence of images. The form of the content signal 104 may be modified to enable implementations involving the content signals 104 of various formats and resolutions.

The signal source 102 is a unit that is capable of providing and/or reproducing one or more images electrically in the form of the content signal 104. Examples of the signal source 102 include a professional grade video tape player with a video tape, a camcorder, a stills camera, a video file server, a computer with an output port, a digital versatile disc (DVD) player with a DVD disc, and the like.

An operator 108 may interact with the encoder 106 to control its operation to encode a message 110 within the content signal 104, thereby producing an encoded content signal 112 that may be provided to a broadcast source 114. The operator 108 may be a person that interacts with the encoder 106 (e.g., through the use of a computer or other electronic control device). The operator 108 may consist entirely of hardware, firmware and/or software, or other electronic control device that directs operation of the encoder 106 in an automated manner.

The encoded content signal 112 may be provided to the broadcast source 114 for distribution and/or transmission to an end-user (e.g., a viewer) who may view the content associated with encoded content signal 112. The broadcast source 114 may deliver the encoded content signal 112 to one or more viewers in formats including analog and/or digital video by storage medium such as DVD, tapes, and other fixed medium and/or by transmission sources such as television broadcast stations, cable, satellite, wireless and Internet sources that broadcast or otherwise transmit content. The encoded content signal 112 may be further encoded (e.g., MPEG encoding) at the broadcast source 114 prior to delivering the encoded content signal 112 to the one or more viewers. Additional encoding may occur at the encoder 106, the broadcast source 114, or anywhere else in the production chain.

The message 110 may be encoded within the content signal 104 to create the encoded content signal 112. Information included in the message 110 may include, by way of example, a web site address, identification data (e.g., who owns a movie, who bought a movie, who produced a movie, where a movie was purchased, etc.), a promotional opportunity (e.g., an electronic coupon), authentication data (e.g., that a user is authorized to receive the content signal), non-pictorial data, and the like. The message 110 may be used to track content (e.g., the showing of commercials). The message 110 may provide an indication of a presence of rights (e.g., a rights assertion mark) associated with the encoded content signal 112, provide electronic game play enhancement, be a uniform resource locator (URL), be an electronic coupon, provide an index to a database, or the like. The message 110 may be a trigger for an event on a device. For example, the events may include a promotional opportunity, electronic game play enhancement, sound and/or lights, and the like. Multiple messages 110 may be encoded within the encoded content signal 112. The message 110 may be shared over multiple frames of the encoded content signal 112.

Encoding of the message 110 may be performed by an encoder subsystem 116 of the encoder 106. An example embodiment of the encoder subsystem 116 is described in greater detail below.

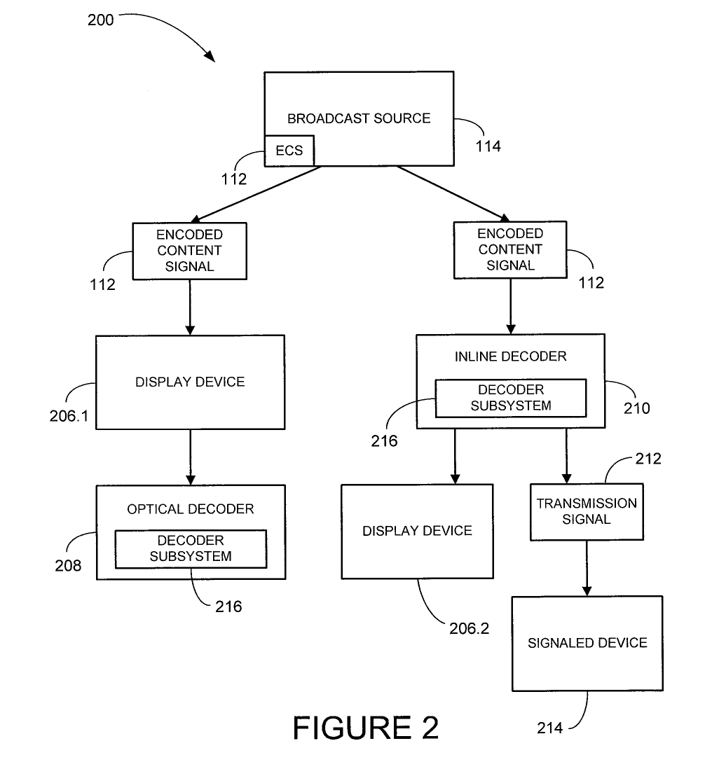

FIG. 2 illustrates an example decoding system 200 according to an example embodiment. The decoding system 200 is an example platform in which one or more embodiments of a decoding method may be used. However, other platforms may also be used.

The decoding system 200 may send the encoded content signal 112 from the broadcast source 114 (see FIG. 1) to a display device 206.1 and/or an inline decoder 210. The inline decoder 210 may receive (e.g., electrically) the encoded content signal 112 from the broadcast source 114, and thereafter may transmit a transmission signal 212 to a signaled device 214 and optionally provide the encoded content signal 112 to a display device 206.2.

The inline decoder 210 may decode the message 110 encoded within the encoded content signal 112 and transmit data regarding the message 110 to the signaled device 214 by use of the transmission signal 212 and provide the encoded content signal 112 to a display device 206.2. The transmission signal 212 may include a wireless radio frequency, infrared and direct wire connection, and other transmission mediums by which signals may be sent and received.

The signaled device 214 may be a device capable of receiving and processing the message 110 transmitted by the transmission signal 212. The signaled device 214 may be a DVD recorder, PC based or consumer electronic-based personal video recorder, and/or other devices capable of recording content to be viewed or any device capable of storing, redistributing and/or subsequently outputting or otherwise making the encoded content signal 112 available. For example, the signaled device 214 may be a hand-held device such as a portable gaming device, a toy, a mobile telephone, and/or a personal digital assistant (PDA). The signaled device 214 may be integrated with the inline decoder 210.

An optical decoder 208 may receive and process the message 110 from a display device 206.1. An implementation of the optical decoder 208 is described in greater detail below.

The display device 206.1 may receive the encoded content signal 112 directly from the broadcast source 114 while the display device 206.2 may receive the encoded content signal 112 indirectly through the inline decoder 210. The display devices 206.1, 206.2 may be devices capable of presenting the content signal 104 and/or the encoded content signal 112 to a viewer such as an analog or digital television, but may additionally or alternatively include a device capable of recording the content signal 104 and/or the encoded content signal 112 such as a digital video recorder. Examples of the display devices 206.1, 206.2 may include, but are not limited to, projection televisions, plasma televisions, liquid crystal displays (LCD), personal computer (PC) screens, digital light processing (DLP), stadium displays, and devices that may incorporate displays such as toys and personal electronics.

A decoder subsystem 216 may be deployed in the optical decoder 208 and/or the inline decoder 210 to decode the message 110 in the encoded content signal 112. An example embodiment of the decoder subsystem 216 is described in greater detail below.

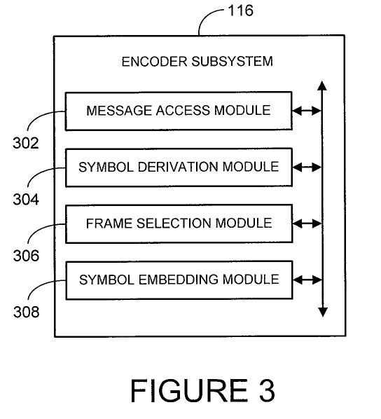

FIG. 3 illustrates an example encoder subsystem 116 that may be deployed in the encoder 106 of the encoding system 100 (see FIG. 1) or otherwise deployed in another system.

The encoder subsystem 116 may include a message access module 302, a symbol derivation module 304, a frame selection module 306, and/or a symbol embedding module 308. Other modules may also be used.

The message access module 302 accesses the message 110 to be encoded into the content signal 104. The content signal 104 may be accessed from the signal source 102.

The symbol derivation module 304 derives one or more symbols to be encoded for the message 110. The symbol derivation module 304 may include a message translator to device the one or more symbols. The message translator may be an application of Reed-Solomon error correction, check sum error correction, cyclical redundancy checks (CRC) and/or bit stuffing encoding. However, other message translators for deriving symbols may also be used.

The frame selection module 306 selects frames for encoding. The frame selection module 306 may select a group of frames from the frames of the content signal 104 for embedding and further select one or more frames from the group of frames for the embedding based on a relationship of the group of frames to the one or more symbols to be embedded in accordance with the message translator.

The symbol embedding module 308 embeds a symbol into one or more frames of the content signal 104 by altering a total pixel variable value of the one or more frames.

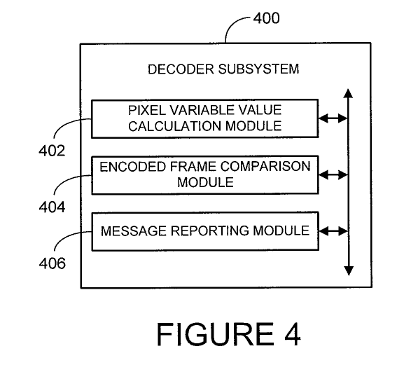

FIG. 4 illustrates an example decoder subsystem 400 that may be deployed in the optical decoder 208 and/or the inline decoder 210 of the decoding system 200 as the decoder subsystem 216 (see FIG. 2) or otherwise deployed in another system.

The decoder subsystem 400 may include a pixel variable value calculation module 402, an encoded frame comparison module 404, and/or a message reporting module 406. Other modules may also be used.

A pixel variable value calculation module 402 calculates total pixel variable value of a frame of the content signal 104 (e.g., the encoded content signal 112) and/or calculates an average total pixel variable value of a plurality of preceding frames. By way of example, the total pixel variable value may be a total luminance value and the average total pixel variable value may be an average luminance value or the total pixel variable value may be a total chrominance value and the average total pixel variable value may be an average chrominance value. In an example embodiment, other statistically detectable values may be calculated and used with the subsystem 400 and related methods including, without limitation, an average pixel variable value, a mean pixel variable value or a median pixel variable value.

An encoded frame comparison module 404 determines whether the frame has been encoded in accordance with a comparison of the total pixel variable value of the frame and the average total pixel variable value of the plurality of proceeding frames.

A message reporting module 406 reports a message presence or a message absence in accordance with the whether the message 110 was determined to be present by the encoded frame comparison module 404.

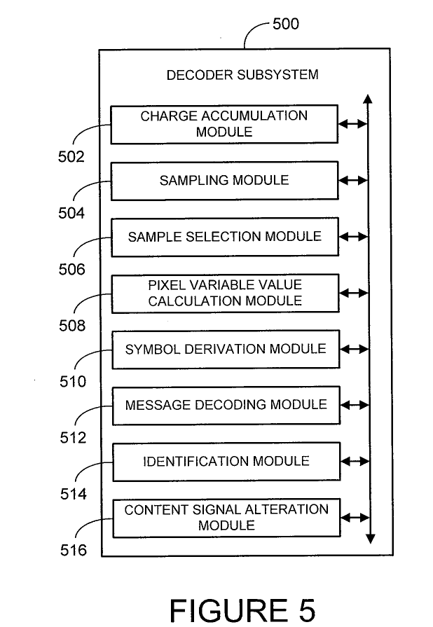

FIG. 5 illustrates an example decoder subsystem 500 that may be deployed in the optical decoder 208 and/or the inline decoder 210 of the decoding system 200 as the decoder subsystem 216 (see FIG. 2) or otherwise deployed in another system.

The decoder subsystem 500 may include a charge accumulation module 502, a sampling module 504, a sample selection module 506, a pixel variable value calculation module 508, a symbol derivation module 510, a message decoding module 512, an identification module 514, and/or content signal alteration module 516. Other modules may also be used.

The charge accumulation module 502 accumulates charge received for a number of intervals during one or more symbol periods. The accumulated charge may be received through use of a photodetector from the encoded content signal 112 presented on the display device 206.1, 206.2. The number of intervals may be at the symbol rate or at a rate higher than the symbol rate. The symbol rate may be a time for a single symbol to be presented within one or more frames of the encoded content signal 112.

The sampling module 504 takes one or more samples of the accumulated charge accumulated by the charge accumulation module 502 during a symbol period.

The sample selection module 506 selects a sample within a symbol period that is in a same position as another sample taken during a different interval within a different symbol period.

The pixel variable value calculation module 508 calculates a total pixel variable value based on the sample (e.g., as selected by the sample selection module 506) and one or more neighboring samples.

The symbol derivation module 510 utilizes one or more total pixel variable values for a symbol period to derive a symbol for the symbol period.

The message decoding module 512 decodes the message 110 encoded within the encoded content signal 112 in accordance with the at least one sample and/or processes the derived symbol from the symbol period through a message transition layer to decode the message 110.

The identification module 514 identifies one or more encoded frames within the encoded content signal 112 in accordance with the at least one sample. The encoded frames may be associated with the message 110. The content signal alteration module 516 alters the encoded content signal 112 to scramble the message 110 within the encoded content signal 112 (e.g., to prevent the message 110 from being decoded).

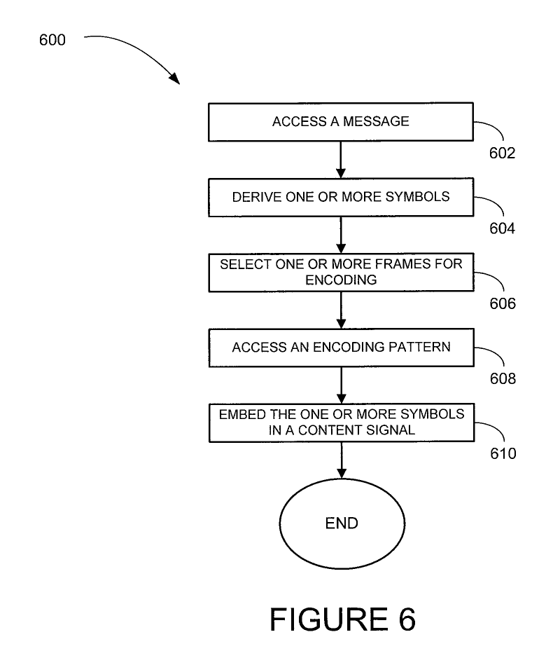

FIG. 6 illustrates a method 600 for content signal encoding according to an example embodiment. The method 600 may be performed by the encoder 106 (see FIG. 1) or otherwise performed.

The message 110 to be encoded into the content signal 104 is accessed at block 602. For example, the message 110 may be received from the operator 108 (see FIG. 1). At block 604, one or more symbols to be encoded for the message 110 are derived by a message translator.

At block 606, a group of frames may be selected from the frames of the content signal 104 for embedding. One or more frames may be selected from the group of frames for the embedding during the operations at block 606 based on a relationship of the group of frames to the one or more symbols to be embedded by the message translator. For example, knowing a total luminance of one or more previous frames and/or the message translator may determine whether a frame is selected. The frames selected for embedding may include a number of consecutive and/or nonconsecutive frames of the content signal 104.

An encoding pattern may be accessed at block 608. The encoding pattern may include, by way of example, a pattern of a consistent change in variable value throughout a frame, a pattern of encoding at one or more edges of an image within the a frame, a signal hiding pattern, a signal limiting pattern, a quantization pattern, and the like. Other encoding patterns may also be used.

At block 610, one or more symbols are embedded into the content signal 104 by altering a total pixel variable value of the one or more frames of the content signal 104. For example, the total pixel variable value of one or more frames may be increased and the total pixel variable value of one or more frames may be decreased. The total pixel variable value may be total luminance value, total chrominance value, or the like. Embedding the one or more symbols into the content signal 104 may create the encoded content signal 112.

The one or more symbols may be embedded into one or more frames by altering a pixel variable value of a number of pixels of the one or more frames in accordance with the encoding pattern. The altering of the pixel variable value of the pixels may alter the total pixel variable value of a frame.

The embedding of the particular symbol may include quantizing total pixel variable value of a frame in a quantization pattern. A pixel variable value a number of pixels of the frame may be quantized to a higher value for an increase in the total pixel variable value or to a lower value for a decrease in the total pixel variable value. The quantization may include, by way of example, rounding the luminance value of a pixel up or down when converting a pixel from a first amount of bit resolution content (e.g., 10 bit video) to a second amount of bit resolution content (e.g., 7 bit video).

In an example embodiment, the embedding of a symbol may include modifying total pixel variable value of a frame by a particular magnitude of a number of available magnitudes. The particular magnitude may be associated with a particular symbol of the one or more symbols.

The total pixel variable value of the one or more frames of the may be altered in accordance with a Manchester encoding scheme. However, other encoding schemes may also be used. The total pixel variable value may be altered at a low amplitude so as to render the modifications to the at least one frame of the content signal 104 substantially invisible (e.g., in a substantially invisible way) to a human.

One or more frames of the content signal may not have total pixel variable value altered because of natural changes (e.g., a big step change) in the frame relative to other frames. In an example embodiment, a synchronization pattern may be used during operation of the method 600 for error correction.

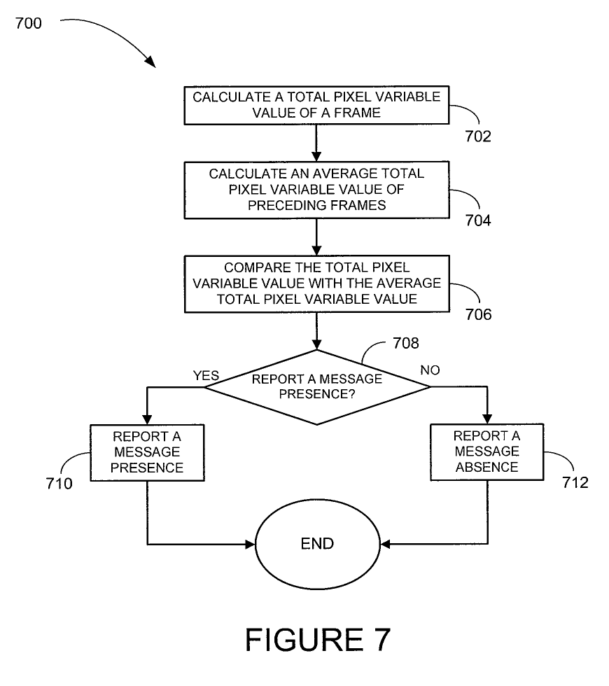

FIG. 7 illustrates a method 700 for signal decoding according to an example embodiment. The method 700 may be performed by the optical decoder 208, the inline decoder 210 (see FIG. 2) or otherwise performed.

A total pixel variable value of a frame of the content signal 104 (e.g., the encoded content signal 112) is calculated at block 702. For example, charge may be received (e.g., through detection of light by use of a photodetector) from the encoded content signal 112 as presented on the display device 206.1, 206.2 and accumulated to determine a total pixel variable value of a frame of the encoded content signal 112.

An average total pixel variable value of a number of preceding frames is calculated at block 704.

At block 706, a comparison of the total pixel variable value of the frame to the average total pixel variable value of the proceeding frames is made to determine whether the frame has been encoded. For example, if the comparison determines that the difference exceeds a threshold then the frame may be determined to be encoded.

A determination may be made at decision block 708 whether to report a message presence based on the result of the comparison. If a determination is made to report a message presence, a message presence may be reported at block 710. If a determination is made at decision block 708 not to report a message presence, a message absence may be reported at block 712.

In an example embodiment, the determining may include determining whether a difference between the total pixel variable value of the frame and the average total pixel variable value of the number of preceding frames is greater than a pixel variable value threshold.

FIG. 8 illustrates a method 800 for signal decoding according to an example embodiment. The method 800 may be performed by the optical decoder 208, the inline decoder 210 (see FIG. 2) or otherwise performed.

At block 802, charge received may be accumulated for a number of intervals during one or more symbol periods. The accumulated charge may be received through use of a photodetector from the encoded content signal 112 presented on the display device 206.1, 206.2. By way of example, accumulating a charge during the operations at block 802 may include detecting the encoded content signal 112 on the display device 206.1, 206.2 with a photodetector during an interval receive a current for the interval, providing the current to a capacitor to create a voltage, and measuring the voltage to obtain a value accumulated as charge for the interval.

An interval of the number of intervals may be at the symbol rate or a rate higher than the symbol rate. The symbol rate may be the time for a single symbol to be presented within one or more frames of the encoded content signal 112.

At block 804, one or more samples of the accumulated charge is taken during a symbol period. For example, the accumulated charge may be sampled a number of times (e.g., 1 time, 2 times, 4 times, 10, times, 20 times, etc.) during a single symbol period during the operations at block 804.

The message 110 encoded within the encoded content signal 112 is decoded in accordance with the one or more samples at block 806.

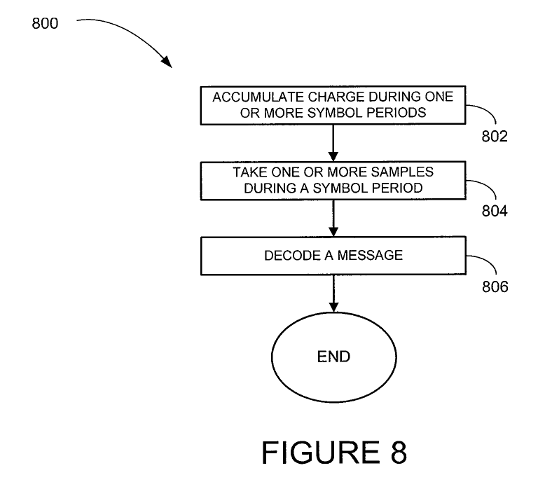

FIG. 9 illustrates a method 900 for message decoding according to an example embodiment. The method 900 may be performed at block 806 (see FIG. 8) or otherwise performed.

At block 902, a sample is selected during an interval that is in a same position within a symbol period as another sample taken during another interval within a different symbol period.

A total pixel variable value is calculated based on a selected sample and one or more neighboring samples at block 904. For example, a number of surrounding samples (e.g., five or ten samples) may be taken to calculate a total pixel variable value of a frame.

A total pixel variable value may be utilized for the symbol period to derive a symbol at block 906.

At block 908, the derived symbol from the symbol period and/or one or more additional derived symbols from one or more different symbol periods are processed through the message transition layer to decode the message 110.

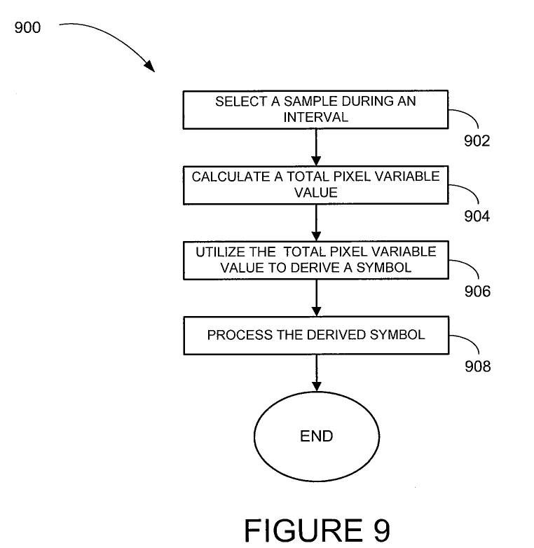

FIG. 10 illustrates a method 1000 for total pixel variable value utilization according to an example embodiment. The method 1000 may be performed at block 906 (see FIG. 9) or otherwise performed.

The total pixel variable value of a sample is compared to a prior sample to determine a change in the total variable value (e.g., a subtle change in luminance) at block 1002. The comparison may be a first derivative calculation (e.g., a rate of change in a total luminance value between the sample and the prior sample) and/or a second derivative calculation (e.g., a rate of change of the rate of change in the total luminance value between the sample and the prior sample).

The symbol for the symbol period is derived in accordance with the change in the total variable value at block 1004.

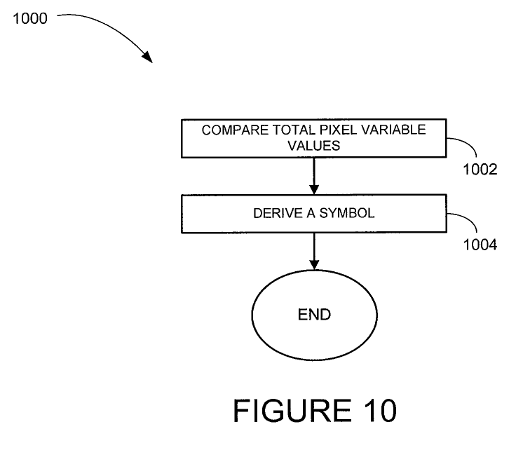

FIG. 11 illustrates an example display 1100 in which samples 1108-1118 are shown to have been taken from symbol period 1102, samples 1120-1128 are shown to have been taken from symbol period 1104, and samples 1128-1136 are shown to be taken from symbol period 1136. However, a different number of samples may be taken from the symbol periods 1102-1106. A different number of symbol periods of the encoded content signal 112 may also be analyzed.

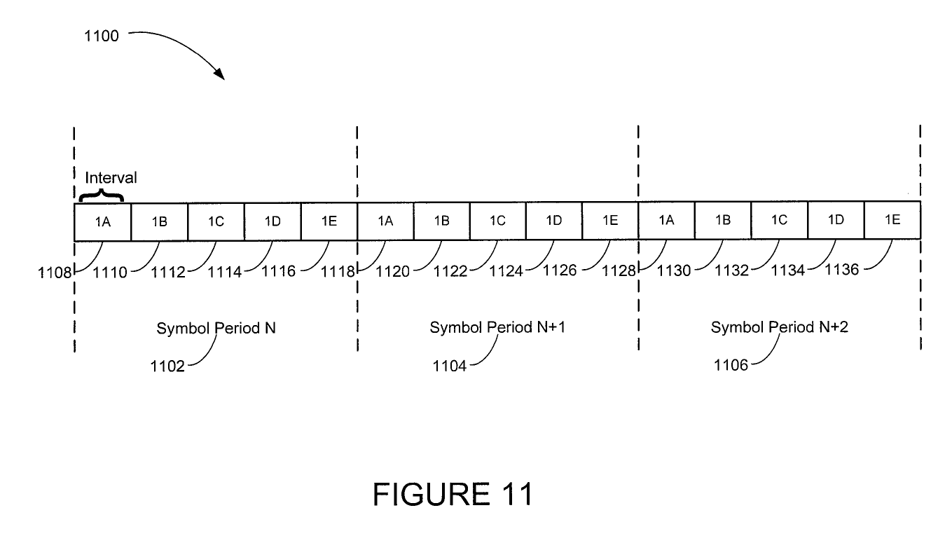

FIG. 12 illustrates a method 1200 for signal circumvention according to an example embodiment. The method 1200 may be performed by the optical decoder 208, the inline decoder 210 (see FIG. 2) or otherwise performed.

At block 1202, charge received for a number of intervals is accumulated during one or more symbol periods. The accumulated charge may be received through use of a photodetector from the encoded content signal 112 presented on the display device 206.1, 206.2.

At block 1204, one or more samples of accumulated charge are taken during a symbol period of the one or more symbol periods.

One or more encoded frames associated with the message 110 are identified in accordance with one or more samples at block 1206.

The encoded content signal 112 including the one or more encoded frames is altered to scramble the message 110 at block 1208. The altering may include repeating a frame associated with the encoded content signal 112 and substituting with the repeated frame for one or more of the encoded frames. The altering may include modifying total pixel variable value of one or more encoded frames. The total pixel variable value may be modified by frame filtering, insertion of an inverted signal, insertion of a negative signal, and/or insertion of a random signal. Other alternations to the encoded content signal 112 to scramble the message 110 may also be used.

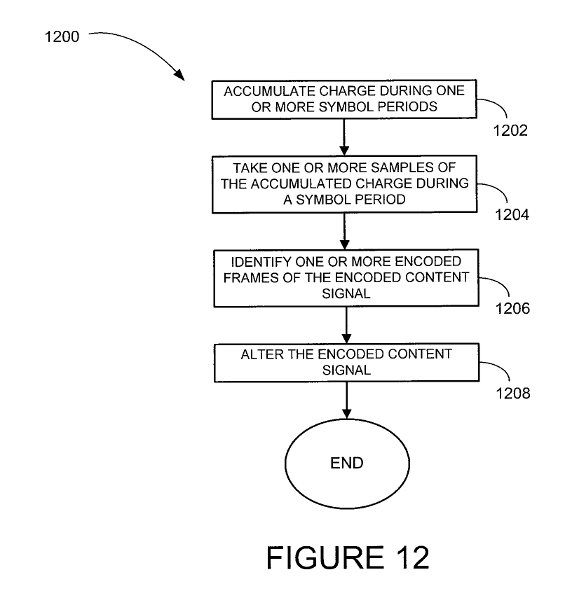

FIG. 13 illustrates an example encoder 106 (see FIG. 1) that may be deployed in the encoding system 100 or another system.

The encoder 106 may be a computer with specialized input/output hardware, an application specific circuit, programmable hardware, an integrated circuit, an application software unit, a central process unit (CPU) and/or other hardware and/or software combinations.

The encoder 106 may include an encoder processing unit 1302 that may direct operation of the encoder 106. For example, the encoder processing unit 1302 may alter attributes of the content signal 104 to produce the encoded content signal 112 containing the message 110.

A digital video input 1304 may be in operative association with the encoder processing unit 1302 and may be capable of receiving the content signal 104 from the signal source 102. However, the encoder 106 may additionally or alternatively receive an analog content signal 104 through an analog video input 1306 and an analog-to-digital converter 1308. For example, the analog-to-digital converter 1308 may digitize the analog content signal 104 such that a digitized content signal 104 may be provided to the encoder processing unit 1302.

An operator interface 1310 may be operatively associated with encoder processing unit 1302 and may provide the encoder processing unit 1302 with instructions including where, when and/or at what magnitude the encoder 106 should selectively raise and/or lower a pixel value (e.g., the luminance and/or chrominance level of one or more pixels or groupings thereof at the direction of the operator 108). The instructions may be obtained by the operator interface 1310 through a port and/or an integrated operator interface. However, other device interconnects of the encoder 106 may be used including a serial port, universal serial bus (USB), “Firewire” protocol (IEEE 1394), and/or various wireless protocols. In an example embodiment, responsibilities of the operator 108 and/or the operator interface 1310 may be partially or wholly integrated with the encoder software 1314 such that the encoder 106 may operate in an automated manner.

When encoder processing unit 1302 receives operator instructions and the content signal 104, the encoder processing unit 1302 may store the luminance values and/or chrominance values as desired of the content signal 104 in storage 1312. The storage 1312 may have the capacity to hold and retain signals (e.g., fields and/or frames of the content signal 104 and corresponding audio signals) in a digital form for access (e.g., by the encoder processing unit 1302). The storage 1312 may be primary storage and/or secondary storage, and may include memory.

After modulating the content signal 104 with the message 110, the encoder 106 may send the resulting encoded content signal 112 in a digital format through a digital video output 1316 or in an analog format by converting the resulting digital signal with a digital-to-analog converter 1318 and outputting the encoded content signal 112 by an analog video output 1320.

The encoder 106 need not include both the digital video input 1304 and the digital video output 1316 in combination with the analog video input 1306 and the analog video output 1320. Rather, a lesser number of the inputs 1304, 1306 and/or the outputs 1316, 1320 may be included. In addition, other forms of inputting and/or outputting the content signal 104 (and the encoded content signal 112) may be interchangeably used.

In an example embodiment, components used by the encoder 106 may differ when the functionality of the encoder 106 is included in a pre-existing device as opposed to a stand alone custom device. The encoder 106 may include varying degrees of hardware and/or software, as various components may interchangeably be used.

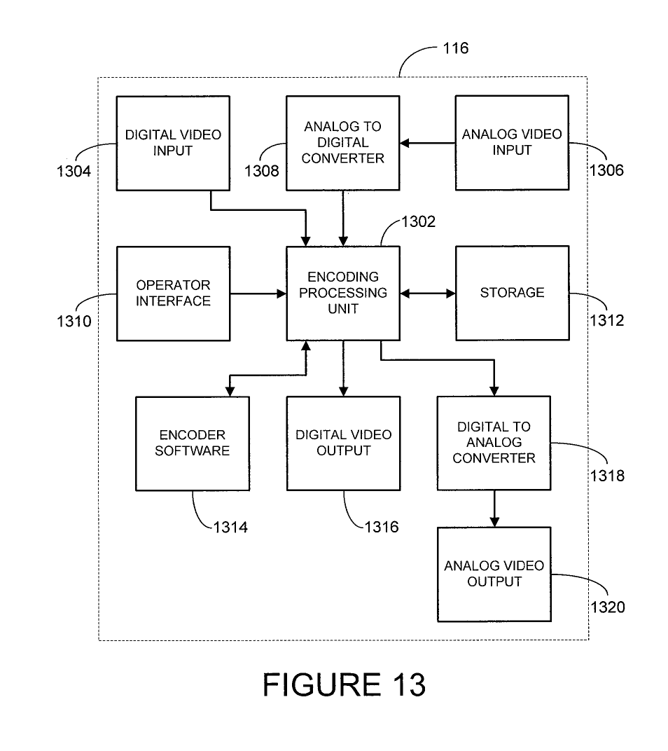

FIG. 14 illustrates an example optical decoder 208 (see FIG. 2) that may be deployed in the decoding system 200 or another system.

The optical decoder 208 may include an imaging sensor device 1406 operatively associated with an analog-to-digital converter 1408 and a decoder processing unit 1402 to optically detect the encoded content signal 112 (e.g., as may be presented on the display device 206.1, 206.2 of FIG. 2).

In an example embodiment, the imaging sensor device 1406 may be a CMOS (Complimentary Metal Oxide Semiconductor) imaging sensor, while in another example embodiment the imaging sensor device may be a CCD (Charge-Coupled Device) imaging sensor. The imaging sensor device 1406 may be in focus to detect motion on the display device 206.1, 206.2 relative to background.

The decoder processing unit 1402 may be an application specific circuit, programmable hardware, integrated circuit, application software unit, and/or hardware and/or software combination. The decoder processing unit 1402 may store the values (e.g., luminance, chrominance, or luminance and chrominance) of the encoded content signal 112 in storage 1412 and may detect pixels that have increased and/or decreased pixel values. The decoder processing unit 1402 may process the encoded content signal 112 to detect the message 110.

A filter 1404 may be placed over a lens of the imaging sensor device 1406 to enhance the readability of the message 110 contained within the encoded content signal 112. For example, an optical filter (e.g., a red filter or a green filter) may be placed over a lens of the imaging sensor device 1406. A digital filter and other types of filters may also be used.

A signal output 1414 may be electrically coupled to the decoder processing unit 1402 and provide a data output for the message 110 and/or data associated with the message 110 after further processing by the optical decoder 208. For example, the data output may be one-bit data and/or multi-bit data.

An optional visual indicator 1416 may be further electrically coupled to the decoder processing unit 1402 and may provide a visual and/or audio feedback to a user of the optical decoder 208, which may by way of example include notice of availability of promotional opportunities based on the receipt of the message.

The decoder processing unit 1402 may store the pixel variable values of the encoded content signal 112 in the storage 1412 and detect the alteration to the pixel variable values of the encoded content signal 112. In an example embodiment, the functionality of the storage 1412 may include the functionality of the storage 1412 (see FIG. 14).

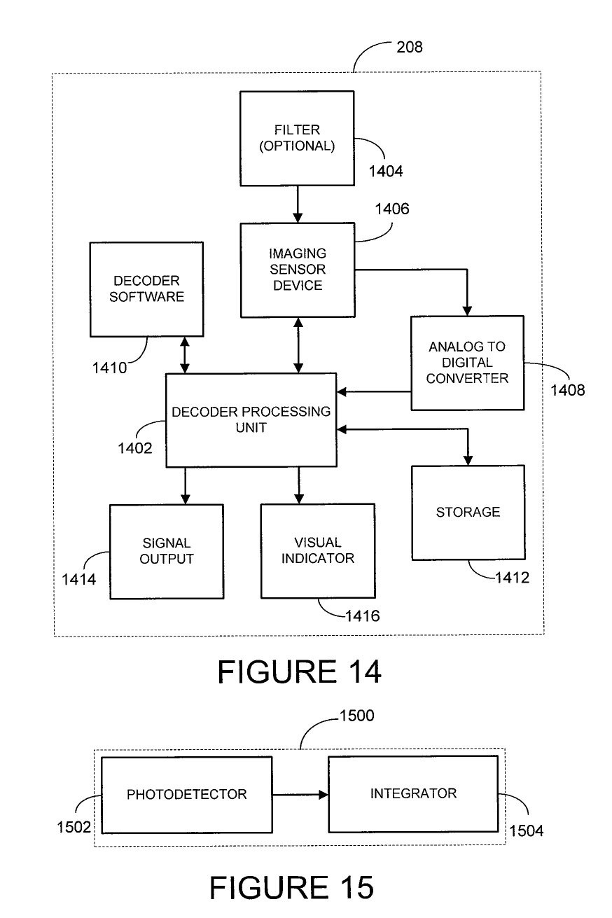

FIG. 15 illustrates an example optical sensor device 1500. The imaging sensor device 1406 (see FIG. 14) may include the functionality of the optical sensor device 1500 or the imaging sensor device 1406 may be otherwise deployed.

The optical sensor device 1500 includes a photodetector 1502 and an integrator 1504. The photodetector 1502 may optically receive the encoded content signal 112 from the display device 206 and may make a reading (e.g., of an amount of chrominance and/or luminance). Examples of photodetectors 1502 may include a photodiode, a phototransistor, a phototube containing a photocathode, and the like.

The integrator 1504 may accumulate a value from the readings made by the photodetector 1502. The accumulated value may be provided to the analog-to-digital converter 1408 and may be reset by the decoder processing unit 1402 (see FIG. 14).

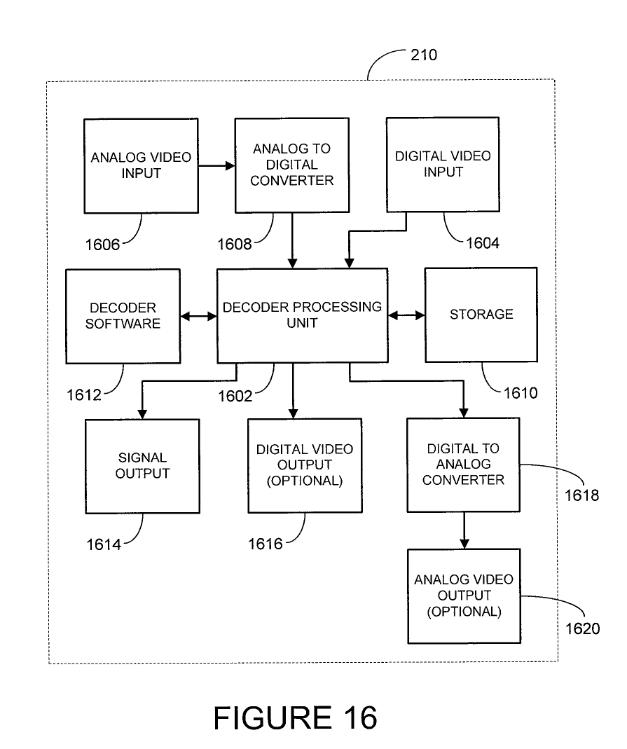

FIG. 16 illustrates an example inline decoder 210 (see FIG. 2) that may be deployed in the decoding system 200 or another system.

The inline decoder 210 may include an analog video input 1606 to receive the encoded content signal 112 from the broadcast source 114 when the encoded content signal 112 is an analog format, and a digital video input 1604 for receiving the encoded content signal 112 when the encoded content signal 112 is in a digital format. For example, the digital video input 1604 may directly pass the encoded content signal 112 to a decoder processing unit 1602, while the analog video input 1606 may digitize the encoded content signal 112 by use of an analog-to-digital converter 1608 before passing the encoded content signal 112 to the decoder processing unit 1602. However, other configurations of inputs and/or outputs of encoded content signal 112 may also be used.

The decoder processing unit 1602 may process the encoded content signal 112 to detect the message 110. The decoder processing unit 1602 may be an application specific circuit, programmable hardware, integrated circuit, application software unit, and/or hardware and/or software combination. The decoder processing unit 1602 may store the pixel values (e.g., luminance, chrominance, or luminance and chrominance) of the encoded content signal 112 in storage 1610 and may detect pixels that have increased or decreased pixel values. The decoder processing unit 1602 may process the encoded content signal 112 to detect the message 110.

The message 110 may be transferred from the inline decoder 210 to the signaled device 214 (see FIG. 2) by a signal output 1614. The inline decoder 210 may optionally output the encoded content signal 112 in a digital format through a digital video output 1616 and/or in an analog format by first converting the encoded content signal 112 from the digital format to the analog format by use of an digital-to-analog converter 1618, and then outputting the encoded content signal 112 through an analog video output 1620. However, the inline decoder 210 need not output the encoded content signal 112 unless otherwise desired.

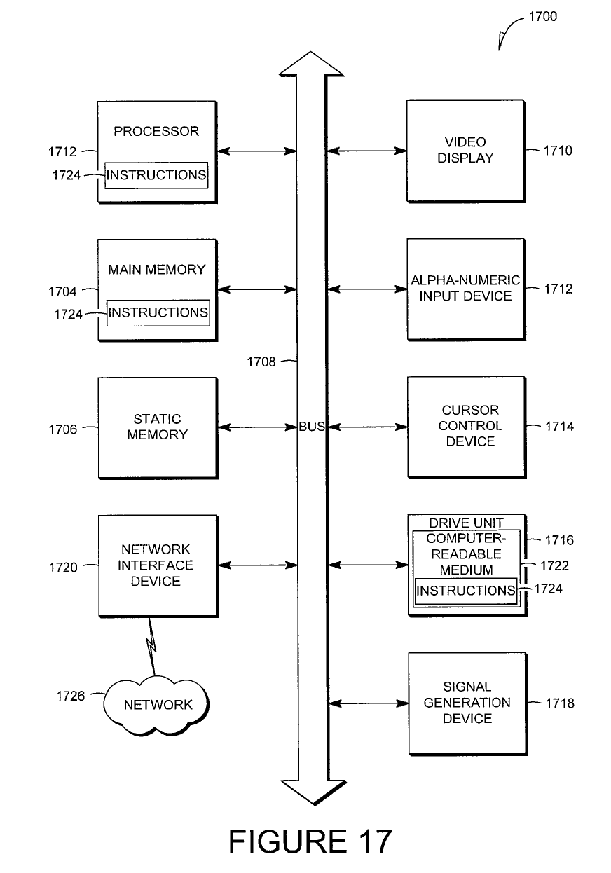

FIG. 17 shows a diagrammatic representation of machine in the example form of a computer system 1700 within which a set of instructions may be executed causing the machine to perform any one or more of the methods, processes, operations, or methodologies discussed herein. The signal source 102, the encoder 106, the broadcast source 114, the display device 206.1, 206.2, the optical decoder 208, the inline decoder 210, and/or the signaled device 214 may include the functionality of the computer system 1700.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU) a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard), a cursor control device 1714 (e.g., a mouse), a drive unit 1716, a signal generation device 1718 (e.g., a speaker) and a network interface device 1720.

The drive unit 1716 includes a machine-readable medium 1722 on which is stored one or more sets of instructions (e.g., software 1724) embodying any one or more of the methodologies or functions described herein. The software 1724 may also reside, completely or at least partially, within the main memory 1704 and/or within the processor 1702 during execution thereof by the computer system 1700, the main memory 1704 and the processor 1702 also constituting machine-readable media.

The software 1724 may further be transmitted or received over a network 1726 via the network interface device 1720.

While the machine-readable medium 1722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for content signal encoding and decoding have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a message to be encoded into a content signal, the content signal include a plurality of frames;
deriving one or more symbols to be encoded for the message in accordance with a message translator; and
embedding a particular symbol of the one or more symbols into at least one frame of the plurality of frames by altering a total pixel variable value of the at least one frame.

2. The method of claim 1, further comprising:
selecting a group of frames from the plurality of frames for embedding; and
selecting the at least one frame from the group of frames for the embedding based on a relationship of the group of frames to the one or more symbols to be embedded in accordance with the message translator.

3. The method of claim 1, further comprising
accessing an encoding pattern;
wherein the embedding of the particular symbol into the at least one frame is by altering a pixel variable value of a plurality of pixels of the at least one frame in accordance with the encoding pattern, the total pixel variable value of the at least one frame being altered by the altering of the pixel variable value of the plurality of pixels.

4. The method of claim 3, wherein the encoding pattern comprises at least one of:
a pattern of a consistent change in luminance throughout the at least one frame,
a pattern of encoding at one or more edges of an image within the at least one frame,
a signal hiding pattern,
a signal limiting pattern,
a quantization pattern, or
combinations thereof.

5. The method of claim 1, wherein the embedding of the particular symbol comprises:
embedding the particular symbol into the at least one frame by quantizing total luminance of the at least one frame in a quantization pattern, a luminance value of a plurality of pixels of the at least one frame quantized to a higher value for an increase in the total luminance or to a lower value for a decrease in the total luminance.

6. The method of claim 1, wherein the embedding of the particular symbol comprises:
embedding the particular symbol of the one or more symbols into the at least one frame by modifying total luminance of a particular frame of the at least one frame by a particular magnitude of a plurality of available magnitudes, the particular magnitude associated with a particular symbol of the one or more symbols.

7. A method comprising:
calculating total pixel variable value of a frame of a content signal;
calculating an average total pixel variable value of a plurality of preceding frames; and
comparing the total pixel variable value of the frame to the average total pixel variable value of the plurality of proceeding frames to determine whether the frame has been encoded.

8. The method of claim 7, further comprising:
reporting a message presence in accordance with the determining.

9. The method of claim 7, wherein the comparing comprises:
determining whether a difference between the total pixel variable value of the frame and the average total pixel variable value of the plurality of preceding frames is greater than a pixel variable value threshold to determine whether the frame has been encoded.

10. The method of claim 7, wherein the total pixel variable value is a total luminance value and the average total pixel variable value is an average luminance value.

11. A method comprising:
accumulating charge received for a number of intervals during one or more symbol periods, the accumulated charge received through use of a photodetector from an encoded content signal presented on a display device;
taking at least one sample of the accumulated charge during a particular symbol period of the one or more symbol periods; and
decoding a message encoded within the encoded content signal in accordance with the at least one sample.

12. The method of claim 11, wherein an interval of the number of intervals is at a symbol rate, the symbol rate being a time for a single symbol to be presented within one or more frames of the encoded content signal.

13. The method of claim 11, wherein the decoding of the message comprises:
selecting a particular sample during a particular interval of the number of internals in a same position within a particular symbol period as an another sample taken during another interval within the particular symbol period;
calculating a particular total pixel variable value based on the particular sample and one or more neighboring samples;
utilizing one or more total pixel variable values for the particular symbol period to derive a particular symbol, the one or more total pixel variable values including the particular total pixel variable value; and
processing the derived symbol from the particular symbol period through a message transition layer to decode the message.

14. The method of claim 13, wherein the utilizing of the total pixel variable values comprises:
comparing the particular total pixel variable value of the particular samples to a prior selected sample to determine a change in the total variable value; and
deriving the particular symbol for the particular symbol period in accordance with the change in the total variable value.

15. The method of claim 13, wherein the processing of the derived symbol comprises:
processing the derived symbol from the particular symbol period and an additional derived symbol from a different symbol period through the message transition layer to decode the message.

16. A method comprising:
accumulating charge received for a number of intervals during one or more symbol periods, the accumulated charge received through use of a photodetector from an encoded content signal presented on a display device;
taking at least one sample of the accumulated charge during a particular symbol period of the one or more symbol periods; and
identifying at least one encoded frame within the encoded content signal in accordance with the at least one sample, the at least one encoded frame being associated with a message; and
altering the encoded content signal in accordance with the identifying of the at least one encoded frame to scramble the message within the encoded content signal.

17. The method of claim 16, wherein the altering of the encoded content signal comprises:
repeating a frame of a plurality of frames associated with the encoded content signal; and
substituting the at least one encoded frame with the repeated frame to scramble the message within the encoded content signal.

18. The method of claim 16, wherein the altering of the encoded content signal comprises:
modifying total pixel variable value of the at least one encoded frame scramble the message within the encoded content signal.

19. The method of claim 18, wherein the modifying of the total pixel variable value is in accordance with at least one of frame filtering, insertion of an inverted signal, insertion of a negative signal, insertion of a random signal, or combinations thereof.

20. A machine-readable medium comprising instructions, which when implemented by one or more processors perform the following operations:
accumulate charge received for a number of intervals during one or more symbol periods, the accumulated charge received through use of a photodetector from an encoded content signal presented on a display device;
take at least one sample of the accumulated charge during a particular symbol period of the one or more symbol periods; and
decode a message encoded within the encoded content signal in accordance with the at least one sample.

21. The machine-readable medium of claim 20, wherein the one or more instructions to decode the message include:
select a particular sample during a particular interval of the number of internals in a same position within a particular symbol period as an another sample taken during another interval within the particular symbol period;
calculate a particular total pixel variable value based on the particular sample and one or more neighboring samples;
utilize one or more total pixel variable values for the particular symbol period to derive a particular symbol, the one or more total pixel variable values including the particular total pixel variable value; and
process the derived symbol from the particular symbol period through a message transition layer to decode the message.

22. The machine-readable medium of claim 20, wherein an interval of the number of intervals is at a rate higher than the symbol rate.

23. The machine-readable medium of claim 20, wherein the comparing is in accordance with a first derivative calculation.

24. The machine-readable medium of claim 20, wherein the comparing is in accordance with a second derivative calculation.

25. A system comprising:
a message access module to access a message to be encoded into a content signal, the content signal include a plurality of frames;
a symbol derivation module to derive one or more symbols to be encoded for the message in accordance with a message translator, the message accessed from the message access module; and
a symbol embedding module to embed a particular symbol of the one or more symbols into at least one frame of the plurality of frames by altering a total pixel variable value of the at least one frame.
